(19) United States
(12) Patent Application Publication
(10) Pub. No.: US 2022/0239141 A1
(43) Pub. Date: Jul. 28, 2022

(54) VEHICLE BATTERY CONTROL SYSTEM

(71) Applicant: TOYOTA JIDOSHA KABUSHIKI KAISHA, Toyota-shi Aichi-ken (JP)

(72) Inventor: Takayuki Shimauchi, Toyota-shi (JP)

(21) Appl. No.: 17/573,805

(22) Filed: Jan. 12, 2022

(30) Foreign Application Priority Data
Jan. 26, 2021 (JP) 2021-010225

(51) Int. Cl. H02J 7/00; B60L 58/24

(52) U.S. Cl. CPC H02J 7/007194; B60K 1/04; B60L 58/24

(57) ABSTRACT

When an occupant sensor detects no occupant on a rear seat , an output upper limit value or input upper limit value of a battery is increased to set the resulting value as a setting. When the occupant sensor detects an occupant seated on the rear seat, the output upper limit value or input upper limit value of the battery is decreased to set the resulting value as a setting.

### CROSS REFERENCE TO RELATED APPLICATION

This application claims priority to Japanese Patent Application No. 2021-010225 filed on Jan. 26, 2021, which is incorporated herein by reference in its entirety including the specification, claims, drawings, and abstract.

### TECHNICAL FIELD

The present disclosure relates to a battery control system for a vehicle in which a battery is located under an occupant seat.

### BACKGROUND

A vehicle such as an electric vehicle is provided with a drive battery. For example, JP 2015-107728 A discloses an electric vehicle in which a battery is located under a rear seat. For such an electric vehicle, an output upper limit value and an input upper limit value of the battery are set according to a battery temperature by a battery control system, and thus, a cruising distance and traveling performance of the electric vehicle are constant as long as the battery temperature remains unchanged.

### CITATION LIST

PATENT DOCUMENT 1: JP 2015-107728 A

For the above electric vehicle with the battery under the occupant seat, the output upper limit value and the input upper limit value of the battery may be increased to enhance the cruising distance and traveling performance. However, in this case, the occupant seat becomes warmer as the battery temperature increases, resulting in degradation in comfort for an occupant seated on the occupant seat.

### SUMMARY

In light of the above, an object of the present disclosure is to provide a vehicle battery control system that can both enhance the cruising distance and traveling performance of a vehicle and provide comfort for the occupant.

A vehicle battery control system according to the present disclosure includes a battery located under an occupant seat, an occupant detection unit that detects whether an occupant is seated on the occupant seat, and a controller that sets an output upper limit value or an input upper limit value of the battery, and in this system, when the occupant detection unit detects no occupant on the occupant seat, the controller increases the output upper limit value or the input upper limit value of the battery and sets the resulting value as a setting, and when the occupant detection unit detects an occupant seated on the occupant seat, the controller decreases the output upper limit value or the input upper limit value of the battery and sets the resulting value as a setting.

In the vehicle battery control system according to the present disclosure, when an occupant seat other than the occupant seat under which the battery is located is intensively air conditioned, in some embodiments, the controller increases the output upper limit value or the input upper limit value of the battery and sets the resulting value as a setting.

In the vehicle battery control system according to the present disclosure, when the occupant seat under which the battery is located is intensively air conditioned, in some embodiments, the controller decreases the output upper limit value or the input upper limit value of the battery and sets the resulting value as a setting.

The vehicle battery control system according to the present disclosure further includes a battery temperature detection unit that detects a temperature of the battery, and when the temperature of the battery is lower than a predetermined temperature, in some embodiments, the controller increases the output upper limit value or the input upper limit value of the battery and sets the resulting value as a setting.

The vehicle battery control system according to the present disclosure further includes a battery temperature detection unit that detects a temperature of the battery, and when the temperature of the battery is higher than or equal to a predetermined temperature, in some embodiments, the controller decreases the output upper limit value or the input upper limit value of the battery and sets the resulting value as a setting.

With a vehicle battery control system according to the present disclosure, it is possible to both enhance a cruising distance and traveling performance of a vehicle and provide comfort for an occupant.

### BRIEF DESCRIPTION OF DRAWINGS

An embodiment of the present disclosure will be described based on the following figures, wherein:

FIG. 1 is a schematic diagram showing a vehicle battery control system as an example of an embodiment;

FIG. 2 is a block diagram showing a configuration of a controller;

FIG. 3 is a graph indicating a correlation between battery temperature and input and output upper limit values of a battery; and

FIG. 4 is a flow chart indicating a control flow by the controller.

### DESCRIPTION OF EMBODIMENT

An example of an embodiment of the present disclosure will be described in detail hereinafter. In the description below, specific shapes, materials, directions, numerical values, etc. are provided as illustrations for facilitating the understanding of the present disclosure, and can be appropriately changed according to applications, purposes, specifications, and the like.

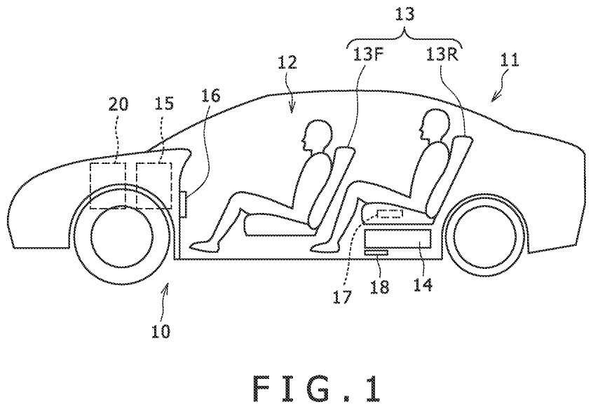

With reference to FIG. 1, a vehicle battery control system 10 will be described as the example of the embodiment. FIG. 1 is a schematic diagram showing the vehicle battery control system 10.

The vehicle battery control system 10 is a system provided in a vehicle 11 in which a battery 14 is located under a rear seat 13R, for changing an output upper limit value or an input upper limit value that is set in advance according to the presence of an occupant seated on the rear seat 13R. With the vehicle battery control system 10, it is possible to both enhance a cruising distance and traveling performance of the vehicle 11 and provide comfort for an occupant as described in detail below.

The vehicle 11 according to the present example is an electric vehicle that uses the charged battery 14 and runs on a motor, but this is not limiting. The vehicle may be a hybrid vehicle, for example.

The vehicle battery control system 10 has a plurality of occupant seats 13 which are provided in a vehicle interior 12 and on which occupants sit, the battery 14 located under the rear seat 13R of the occupant seats 13, an air conditioner 15 that air conditions the vehicle interior 12, and a controller (Electronic controller, ECU) 20 that changes an output upper limit value or an input upper limit value of the battery 14.

The controller 20 of the vehicle battery control system 10 includes an operation unit 16 that can perform setting of intensive air conditioning described below, an occupant sensor 17 serving as an occupant detection unit that detects whether an occupant is seated on the rear seat 13R, and a battery temperature sensor 18 serving as a battery temperature detection unit that detects a temperature of the battery 14.

The occupant seats 13 are seats which are provided in the vehicle interior 12 of the vehicle 11 and on which occupants sit. In the present example, the occupant seats 13 include two front seats 13F arranged in the vehicle width direction on the front side of the vehicle interior and two rear seats 13R arranged in the vehicle width direction on the rear side of the vehicle interior.

The battery 14 is a drive battery, and in some embodiments a lithium ion secondary battery is used as the battery 14. As described above, the battery 14 is located under the rear seat 13R of the occupant seats 13. Although in the present example the battery 14 is located under the rear seat 13R, this is not limiting, and the battery 14 may be located under the front seat 13F.

The air conditioner 15 is an apparatus for air conditioning the vehicle interior 12. The air conditioner 15 has a function of intensively air conditioning a particular occupant seat 13 (for example, the front seat 13F or the rear seat 13R). The operation unit 16 is provided in the vehicle interior 12 and is configured to enable setting of an occupant seat 13 which is to be intensively air conditioned by the air conditioner 15. Information on intensive air conditioning set by the operation unit 16 is transmitted to the controller 20.

The occupant sensor 17 is a sensor that is provided on the backside of a seat surface of the rear seat 13R and detects whether an occupant is seated on the seat according to changes in resistance value of a strain gauge based on the body weight of the occupant on the rear seat 13R. A detection signal generated by the occupant sensor 17 is transmitted to the controller 20.

Although in the present example the occupant sensor 17 is employed as the occupant detection unit, this is not limiting. For example, the occupant detection unit may be configured to detect the entry and exit of an occupant with respect to the rear seat 13R by using a rear door open/close sensor to detect whether the occupant is seated on the rear seat 13R. The occupant detection unit may also be configured to detect buckling of a seat belt of the rear seat 13R by using a seat belt buckle sensor of the rear seat 13R to detect whether an occupant is seated on the rear seat 13R.

The battery temperature sensor 18 is a sensor that is provided near the battery 14 and detects a temperature of the battery 14. A detection signal generated by the battery temperature sensor 18 is transmitted to the controller 20.

The controller 20 has a central processing unit (CPU) which includes a computation unit and a storage unit, such as a random-access memory (RAM), a read-only memory (ROM), and the like. The controller 20 performs signal processing according to a program stored in the ROM in advance while using a temporary storage function of the RAM. The controller 20 will be described in detail below.

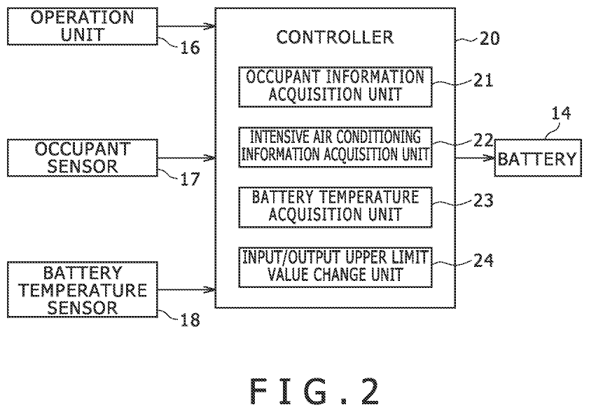

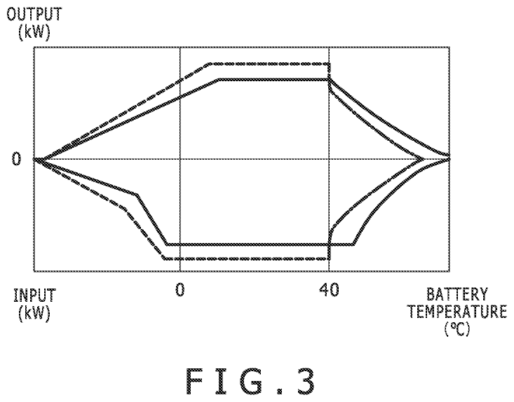

The configuration of the controller 20 will be described with reference to FIGS. 2 and 3. FIG. 2 is a block diagram showing a configuration of the controller 20. FIG. 3 is a graph indicating a correlation between temperature of the battery 14 and input and output upper limit values of the battery 14.

The controller 20 is connected to the operation unit 16, the occupant sensor 17, the battery temperature sensor 18, and the like and receives signals transmitted therefrom. The controller 20 is also connected to the battery 14 and the like and transmits signals thereto.

The controller 20 includes an occupant information acquisition unit 21 that acquires information as to whether an occupant is seated on the rear seat 13R under which the battery 14 is located, an intensive air conditioning information acquisition unit 22 that acquires information on intensive air conditioning by the air conditioner 15, a battery temperature acquisition unit 23 that acquires information on a temperature of the battery 14, and an input/output upper limit value change unit 24 that changes an input upper limit value or an output upper limit value of the battery 14.

When the operation unit 16 sets an occupant seat 13 to be intensively air conditioned, the intensive air conditioning information acquisition unit 22 functions to acquire information on that occupant seat 13 set to be intensively air conditioned. When, for example, the intensive air conditioning information acquisition unit 22 acquires information indicating that the front seat 13F is set to be intensively air conditioned, it is highly likely that no occupant is seated on the rear seat 13R. Also, when, for example, the intensive air conditioning information acquisition unit 22 acquires information indicating that the rear seat 13R is set to be intensively air conditioned, it is highly likely that an occupant is seated on the rear seat 13R and seeks comfort.

When no occupant is seated on the rear seat 13R, the input/output upper limit value change unit 24 functions to increase the input upper limit value or the output upper limit value of the battery 14 to change the setting. When an occupant is seated on the rear seat 13R, the input/output upper limit value change unit 24 functions to decrease the input upper limit value or the output upper limit value of the battery 14 to change the setting.

Here, the input upper limit value is an upper limit value of an input to the battery 14 and includes an upper limit value obtained when power is input to the battery 14 by a regenerative brake and an upper limit value obtained when power is input to the battery 14 by an external charging facility. In addition, the output upper limit value is an upper limit value of an output of the battery 14 obtained when the vehicle 11 is running and includes an upper limit value obtained when power is output from the battery 14 to a drive motor driven according to the accelerator position.

With the input/output upper limit value change unit 24, it is possible to both enhance a cruising distance and traveling performance of the vehicle 11 and provide comfort for an occupant. More specifically, when no occupant is seated on the rear seat 13R, the input/output upper limit value change unit 24 can increase the input upper limit value or output upper limit value of the battery 14 to change the setting, thereby enhancing the cruising distance and traveling performance of the vehicle 11. On the contrary, when an occupant is seated on the rear seat 13R, it can decrease the input upper limit value or output upper limit value of the battery 14 to change the setting, thereby improving the comfort of the rear seat 13R.

The input/output upper limit value change unit 24 may also increase the input upper limit value or the output upper limit value of the battery 14 to change the setting when the front seat 13F is set to be intensively air conditioned. This also makes it possible to prevent a reduction in cruising distance and traveling performance of the vehicle 11 which occurs when the occupant sensor 17 malfunctions; that is, when the occupant sensor 17 detects seat occupation erroneously despite no occupant on the rear seat 13R.

The input/output upper limit value change unit 24 may also decrease the input upper limit value or the output upper limit value of the battery 14 to change the setting when the rear seat 13R is set to be intensively air conditioned. Thus, when an occupant seated on the rear seat 13R is seeking comfort, it is possible to decrease the input upper limit value or output upper limit value of the battery 14 to change the setting.

The input/output upper limit value change unit 24 may also increase the input upper limit value or the output upper limit value of the battery 14 to change the setting when a temperature of the battery 14 is lower than a predetermined temperature (for example, 40° C.). This makes it possible to enhance the safety efficiency of the battery 14 without increasing the battery temperature more than necessary.

The input/output upper limit value change unit 24 may also decrease the input upper limit value or the output upper limit value of the battery 14 to change the setting when a temperature of the battery 14 is higher than or equal to the predetermined temperature (for example, 40° C.). This makes it possible to prevent a reduction in cruising distance and traveling performance of the vehicle 11 more than necessary.

As shown in FIG. 3, the input upper limit value and output upper limit value of the battery 14 are set individually according to a temperature of the battery 14. More specifically, the input/output upper limit value change unit 24 functions to change the settings so as to increase the input upper limit value or the output upper limit value for a normal case (solid lines in FIG. 3) to the input upper limit value or the output upper limit value for the case where there is no occupant (broken lines in FIG. 3). The input/output upper limit value change unit 24 also functions to change the settings so as to decrease the input upper value or the output upper limit value for the normal case to the input upper limit value or the output upper limit value for the case where there is an occupant (long dashed short dashed lines in FIG. 3).

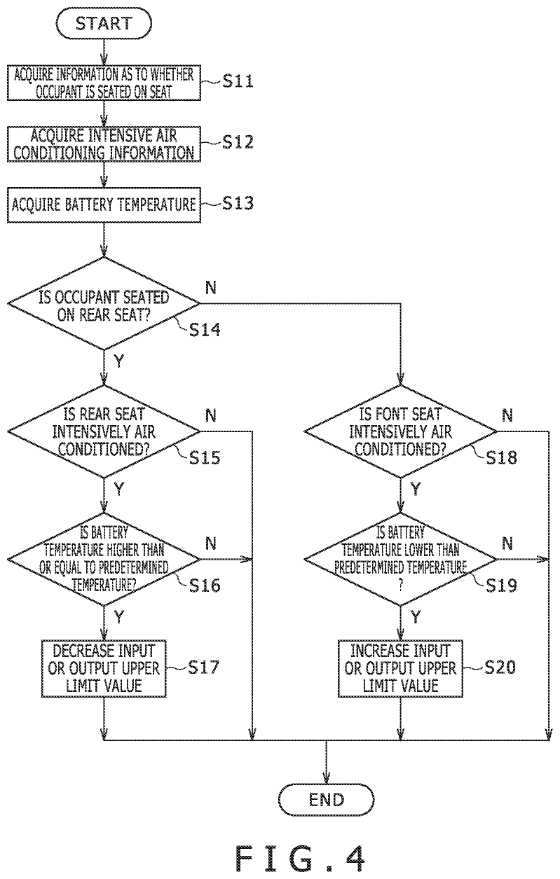

A control flow by the controller 20 will be described with reference to FIG. 4.

As shown in FIG. 4, in step S11, information as to whether an occupant is seated on the rear seat 13R is acquired by the occupant information acquisition unit 21. In step S12, the intensive air conditioning information acquisition unit 22 acquires information on intensive air conditioning set by the operation unit 16. In step S13, the battery temperature acquisition unit 23 acquires a temperature of the battery 14 detected by the battery temperature sensor 18.

In step S14, a decision is made based on the information as to whether the occupant is seated on the rear seat 13R acquired in step S11. When the occupant is seated on the rear seat 13R, the processing proceeds to step S15, while when no occupant is seated on the rear seat 13R, the processing proceeds to step S18.

In step S15, a decision is made based on the information on intensive air conditioning acquired in step S12. When the rear seat 13R is set to be intensively air conditioned, the processing proceeds to step S16. In step S16, a decision is made based on the information on the temperature of the battery 14 acquired in step S13. When the temperature of the battery 14 is higher than or equal to a predetermined temperature (for example 40° C.), the processing proceeds to step S17.

In step S17, the input/output upper limit value change unit 24 decreases the input upper limit value or output upper limit value of the battery 14 to change the setting, thereby improving the comfort of the rear seat 13R. The setting is changed such that, in the graph of FIG. 3, the input upper limit value or the output upper limit value for the normal case (solid lines in FIG. 3) is decreased to the input upper limit value or the output upper limit value for the case where there is an occupant (long dashed short dashed lines in FIG. 3). Step S15 or step S16 may be omitted, and the processing may proceed directly from step S14 to step S17.

Meanwhile, in step S18, a decision is made based on the information on intensive air conditioning acquired in step S12. When the front seat 13F is set to be intensively air conditioned, the processing proceeds to step S19. In step S19, a decision is made based on the information on the temperature of the battery 14 acquired in step S13. When the temperature of the battery 14 is lower than the predetermined temperature (for example 40° C.), the processing proceeds to step S20.

In step S20, the input/output upper limit value change unit 24 increases the input upper limit value or output upper limit value of the battery 14 to change the setting, thereby enhancing the cruising distance and traveling performance of the vehicle 11. The setting is also changed such that, in the graph of FIG. 3, the input upper limit value or the output upper limit value for the normal case (solid lines in FIG. 3) is increased to the input upper limit value or the output upper limit value for the case where there is no occupant (broken lines in FIG. 3). Step S18 or step S19 may be omitted, and the processing may proceed directly from step S14 to step S20.

The present disclosure is not limited to the above embodiment and its variations, and, as a matter of course, various modifications and substitutions can be made without departing from the scope of the claims herein.

1. A vehicle battery control system comprising:
a battery located under an occupant seat;
an occupant detection unit that detects whether an occupant is seated on the occupant seat; and
a controller that sets an output upper limit value or an input upper limit value of the battery wherein
when the occupant detection unit detects no occupant on the occupant seat, the controller increases the output upper limit value or the input upper limit value of the battery and sets the resulting value as a setting, and
when the occupant detection unit detects an occupant seated on the occupant seat, the controller decreases the output upper limit value or the input upper limit value of the battery and sets the resulting value as a setting.

2. The vehicle battery control system according to claim 1, wherein the controller increases the output upper limit value or the input upper limit value of the battery and sets the resulting value as a setting when an occupant seat other than the occupant seat under which the battery is located is intensively air conditioned.

3. The vehicle battery control system according to claim 1, wherein the controller decreases the output upper limit value or the input upper limit value of the battery and sets the resulting value as a setting when the occupant seat is intensively air conditioned.

4. The vehicle battery control system according to claim 1, further comprising a battery temperature detection unit that detects a temperature of the battery, wherein
the controller increases the output upper limit value or the input upper limit value of the battery and sets the resulting value as a setting when the temperature of the battery is lower than a predetermined temperature.

5. The vehicle battery control system according to claim 1, further comprising a battery temperature detection unit that detects a temperature of the battery, wherein
the controller decreases the output upper limit value or the input upper limit value of the battery and sets the resulting value as a setting when the temperature of the battery is higher than or equal to a predetermined temperature.

6. The vehicle battery control system according to claim 2, further comprising a battery temperature detection unit that detects a temperature of the battery, wherein
the controller increases the output upper limit value or the input upper limit value of the battery and sets the resulting value as a setting when the temperature of the battery is lower than a predetermined temperature.

7. The vehicle battery control system according to claim 2, further comprising a battery temperature detection unit that detects a temperature of the battery, wherein
the controller decreases the output upper limit value or the input upper limit value of the battery and sets the resulting value as a setting when the temperature of the battery is higher than or equal to a predetermined temperature.

8. The vehicle battery control system according to claim 3, further comprising a battery temperature detection unit that detects a temperature of the battery, wherein
the controller increases the output upper limit value or the input upper limit value of the battery and sets the resulting value as a setting when the temperature of the battery is lower than a predetermined temperature.

9. The vehicle battery control system according to claim 3, further comprising a battery temperature detection unit that detects a temperature of the battery, wherein
the controller decreases the output upper limit value or the input upper limit value of the battery and sets the resulting value as a setting when the temperature of the battery is higher than or equal to a predetermined temperature.
